(19) United States
(12) Patent Application Publication
(10) Pub. No.: US 2008/0102316 A1
(43) Pub. Date: May 1, 2008

(54) Magneto-resistive magnetic read head and storage apparatus using the same magnetic read head

(75) Inventors: Hideyuki Akimoto, Kawasaki (JP); Jun Masuko, Kawasaki (JP); Naoki Mukouyama, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/977,950

(22) Filed: Oct. 26, 2007

(30) Foreign Application Priority Data
Oct. 30, 2006 (JP) 2006-294057

(51) Int. Cl. G11B 5/39; G11B 5/60

(52) U.S. Cl. 428/811.2; 360/234.3

(57) ABSTRACT

A magnetic read head has a first free-magnetic layer, a second free-magnetic layer, a non-magnetic layer provided between the first free-magnetic layer and the second free-magnetic layer, and a bias applying layer for applying a bias magnetic field in the vertical direction to the medium facing plane of the first free-magnetic layer and the second free-magnetic layer. Shape anisotropies of magnetization of the first free-magnetic layer and the second free-magnetic layer are inclined in the opposite direction with each other for the medium facing plane within film surfaces of respective free-magnetic layers. The first free-magnetic layer and the second free-magnetic layer are overlapped at the medium facing plane in the vertical direction at the surfaces of respective free-magnetic layer films, and the bias applying layer is located on the opposite plane to the medium facing plane of the first free-magnetic layer and the second free-magnetic layer.

The present invention relates to a magnetic read head and a storage apparatus using the same magnetic read head and more specifically, to a highly sensitive magneto-resistive magnetic read head.

### BACKGROUND OF THE INVENTION

In recent years, a large capacity storage apparatus has been required, because rapid development in digital techniques, information application techniques, and storage apparatuses, such as HDD (Hard Disk Drive), have increased recording density. Accordingly, bit size in recording to a magnetic recording medium (hereinafter, referred to as recording medium or simply medium) is also reduced, and a low magnetic flux signal is read from the recording medium. However, a low-level signal cannot be read sufficiently with an inductive head, reading to a medium signal with the electromagnetic inductive effect through the conventional ring core.

Therefore, a magnetoresistive magnetic read head (MR head) has been used because of the reason that a medium signal can be read as a change of resistance through rotation of magnetization of a magnetic thin film in response to magnetic field of medium. A giant magnetoresistive element constituted in the laminated structure of a free-magnetic layer, non-magnetic layer, and pinned-magnetic layer is needed in order to provide twice the sensitivity of the existing magnetoresitive element, namely a spin-valve magnetic read head is often used.

An even larger capacity recording apparatus is required and high density is further improved to such a degree that magnetization of the medium cannot be sensed even with a spin-valve type magnetic read head. For this reason, a higher sensitive tunnel magnetoresistive magnetic read head with a vertical electrical current flow type (CPP: Current Perpendicular to Plane) magnetoresistive magnetic read head has also been employed.

FIGS. 1A, 1B and 1C show structures of the spin-valve type magnetoresistive element of the prior art. FIG. 1A is a side elevation of the spin-valve type magnetoresistive element viewed from the vertical direction at the film surface. FIG. 1B is a cross-sectional view of the spin-valve type magnetoresistive element. FIG. 1C is a side elevation of the spin-valve type magnetoresistive element viewed from the medium facing plane. Element portion 1 consists of a free-magnetic layer 2 rotating in response to a medium magnetic field, a pinned-magnetic layer 3 being fixed in magnetization, a non-magnetic layer 5 positioned between the free-magnetic layer 2 and the pinned-magnetic layer 3, and an anti-ferro-magnetic layer 4 for fixing the pinned-magnetic layer 3 through exchange coupling. A bias applying layer 6a, 6b for applying a bias magnetic field to the free-magnetic layer 2 is located on the right and left sides of the element portion 1 via an underlayer 7a, 7b. The bias magnetic field is applied with bias applying layer 6a, 6b, and Barkhausen noise is controlled by the free-magnetic layer 2 through control of the magnetic domain.

FIGS. 2A, 2B and 2C are schematic diagrams showing magnetization state of the free-magnetic layer and pinned-magnetic layer of the spin-valve type magnetic read head of the prior art. In this figure, the layers other than the free-magnetic layer and pinned-magnetic layer are not illustrated. FIG. 2A shows the magnetization state in the case where no medium magnetic field is generated. The magnetization of the free-magnetic layer 2 is parallel to the medium facing plane because of the magnetic anisotropy and bias magnetic field from the bias applying layer 6a, 6b. Moreover, magnetization of the pinned-magnetic layer 3 is fixed almost in a vertical direction to the medium facing plane with exchange coupling and the anti-ferro-magnetic layer 4. The pinned-magnetic layer may be turned 180°.

When the medium magnetic field 8 is generated, magnetization of the free-magnetic layer 2 is rotated upward or downward in response to the medium magnetic field 8 as shown in FIG. 2B or FIG. 2C. Moreover, magnetization of the pinned-magnetic layer 3 is fixed in a vertical direction to the medium facing plane. Accordingly, a relative angle of magnetization of the free-magnetic layer and the pinned-magnetic layer changes depending on the medium magnetic field 8 and resistance of the element also changes with the magnetoresistive effect. Due to the changing in the resistance, magnetic information on a recording medium is converted into an electrical signal.

As explained above, in the case of the spin-valve type magnetic read head and the tunnel magneto-resistive magnetic read head of the prior art, the pinned-magnetic layer 3 does not respond to the medium magnetic field and only the single soft-magnetic layer (free-magnetic layer 2) rotates in response to the medium magnetic field.

However, when magnetizations of a couple of soft-magnetic layers respectively rotate in the opposite directions with each other responding to the medium magnetic field, relative angle in magnetization of a couple of soft-magnetic layers changes by about two times in comparison with that of the prior art. Therefore, the reading output of about two times can be obtained. The magnetic read head in the structure explained above is shown in FIGS. 3A, 3B and 3C. The magnetic read head of the structure explained above is constituted with a first free-magnetic layer 10 and a second free-magnetic layer 11. For example, when no medium magnetic field is generated, respective free-magnetic layers 10, 11 are designed so that these layers are magnetized in the opposition directions with each other and an angle of elevation for the medium facing plane is set to almost 45°. The layers other than the first free-magnetic layer and the second free-magnetic layer are not illustrated in FIGS. 3A, 3B and 3C, but a non-magnetic layer is located between the first free-magnetic layer and the second free-magnetic layer to constitute a magnetoresistive effect element.

Meanwhile, when the medium magnetic field 8 is generated, magnetizations of respective free-magnetic layers 10, 11 are rotated upward and downward in response to the medium magnetic field 8 as shown in FIG. 3B or FIG. 3C. As a structure of such magnetic read head, Japanese Examined Patent Publication No. 3657916 discloses a structure using a couple of anti-ferro-magnetic layers having different blocking temperatures as the structure of magnetic read head for vertical medium.

However, on the occasion of fixing both end portions of the first free-magnetic layer and the second free-magnetic layer using a couple of anti-ferro-magnetic layers of different blocking temperatures, respective anti-ferro-magnetic layers are required to have the thickness in the range of 5 nm to 20 nm. This is a large problem to attain narrow gap to realize high density recording.

Moreover, the bias applying layers have been located on both sides of the element to control Barkhausen noise and a bias magnetic field has also been applied to the free-magnetic layer. However, this application provides the effect for lowering sensitivity of the free-magnetic layer for the medium magnetic field and also lowers a reading output level.

FIG. 4 is a distribution diagram in the core width direction of the bias magnetic field to the free-magnetic layer for respective magnetic read heads in different element core widths. FIG. 4 is also a simulation result under the conditions that size in the element core width is 88 nm, 148 nm, and 200 nm, size in the element height direction is 112 nm, and tBr of the ferro-magnetic layer as the bias applying layer is 190 Gum. When the element core width is 148 nm and 200 nm, a bias magnetic field at the center of element is 20 Oe or less. Meanwhile, when the element core width is 88 nm, the bias magnetic field at the center of the element becomes 100 Oe or more. The reason is that many regions are placed under the magnetic domain control with the bias magnetic field from the ferro-magnetic layer. The direction indicated by the arrow mark a in FIGS. 1A, 1B and 1C is called the element core width direction, while the direction indicated by the arrow mark b is called the element height direction.

Particularly, in recent years, as the capacity of the storage apparatus is getting larger and even higher recording density is also required in the hard disk, it is required to read ultra-low-level magnetic information recorded in the magnetic disk and the magnetoresistive effect element is further reduced in size. Accordingly, reduction in output due to the bias magnetic field from the bias applying layer is considered as a large problem.

It is an object of the present invention to provide, in view of solving the problems explained above, a highly sensitive magnetoresistive magnetic read head which is constituted with a couple of free-magnetic layers with less reduction of output by the bias applying layer and also provide a storage apparatus utilizing the same magnetic read head.

### SUMMARY OF THE INVENTION

In accordance with an aspect of an embodiment, a magnetic read head reading from a medium forming a medium facing plane has a first free-magnetic layer, a second free-magnetic layer, a non-magnetic layer provided between the first free-magnetic layer and the second free-magnetic layer, and a bias applying layer for applying a bias magnetic field in the vertical direction to the medium facing plane of the first free-magnetic layer and the second free-magnetic layer. Shape anisotropies of magnetization of the first free-magnetic layer and the second free-magnetic layer are inclined in the opposite direction with each other for the medium facing plane within film surfaces of respective free-magnetic layers. The first free-magnetic layer and the second free-magnetic layer are overlapped at the medium facing plane in the vertical direction at the surfaces of respective free-magnetic layer films, and the bias applying layer is located on the opposite plane to the medium facing plane of the first free-magnetic layer and the second free-magnetic layer.

### BRIEF DESCRIPTION OF THE DRAWINGS

The present invention will be explained with reference to the accompanying drawings.

FIG. 1A is a side elevation of the spin-valve type magnetoresistive element of the prior art viewed from the vertical direction at the film surface.

FIG. 1B is a cross-sectional view of the spin-valve type magnetoresistive element being cut at the center thereof.

FIG. 1C is a side elevation of the spin-valve type magnetoresistive element of the prior art viewed from the medium facing plane.

FIG. 2A is a schematic diagram of magnetizing condition of a free-magnetic layer and a pinned-magnetic layer of a spin-valve type magnetic read head of the prior art in the case where no medium magnetic field is generated.

FIG. 2B is a schematic diagram of magnetizing condition of a free-magnetic layer and a pinned-magnetic layer of a spin-valve type magnetic read head of the prior art in the case where medium magnetic field is generated to up-direction.

FIG. 2C is a schematic diagram of magnetizing condition of a free-magnetic layer and a pinned-magnetic layer of a spin-valve type magnetic read head of the prior art in the case where medium magnetic field is generated to down-direction.

FIG. 3A is a schematic diagram of magnetizing condition of the first free-magnetic layer and a second free-magnetic layer of the spin-valve type magnetic read head constituted with the first free-magnetic layer and the second free-magnetic layer in the case where no medium magnetic field is generated.

FIG. 3B is a schematic diagram of magnetizing condition of the first free-magnetic layer and a second free-magnetic layer of the spin-valve type magnetic read head constituted with the first free-magnetic layer and the second free-magnetic layer in the case where medium magnetic field is generated to up-direction.

FIG. 3C is a schematic diagram of magnetizing condition of the first free-magnetic layer and a second free-magnetic layer of the spin-valve type magnetic read head constituted with the first free-magnetic layer and the second free-magnetic layer in the case where medium magnetic field is generated to down-direction.

FIG. 4 is a distribution diagram in the core width direction of the bias magnetic field in the free-magnetic layer.

FIG. 5A is a side elevation of the magnetic read head of the present invention viewed from the vertical direction of the film surface.

FIG. 5B is a cross-sectional view of the magnetic read head of the present invention cut at the center.

FIG. 5C is a side elevation of the magnetic read head of the present invention viewed from the medium facing plane.

FIG. 6A is a schematic diagram of the magnetizing condition of the first free-magnetic layer and the second free-magnetic layer of the magnetic read head of the first embodiment in the case where no medium magnetic field is generated.

FIG. 6B is a schematic diagram of the magnetizing condition of the first free-magnetic layer and the second free-magnetic layer of the magnetic read head of the first embodiment in the case where medium magnetic field is generated to up-direction.

FIG. 6C is a schematic diagram of the magnetizing condition of the first free-magnetic layer and the second free-magnetic layer of the magnetic read head of the first embodiment in the case where medium magnetic field is generated to down-direction.

FIG. 7 is a diagram showing relationship among rotating angle of the free-magnetic layer, asymmetrical property of reading waveform, and tBr of a bias applying layer.

FIG. 8 is a side elevation showing a structure of the magnetic read head of the second embodiment.

FIG. 9 is a side elevation showing a structure of the magnetic read head of the third embodiment.

FIG. 10 is a perspective view of a storage apparatus using the magnetic read head of the present invention.

FIG. 11A is a schematic diagram showing positional relationship among the suspension, slider and the magnetic read head of the present invention.

FIG. 11B is a structure of the magnetic read head and write magnetic head.

### DETAILED DESCRIPTION

The preferred embodiments of the present invention will be explained in detail with reference to the accompanying drawings.

### First Embodiment

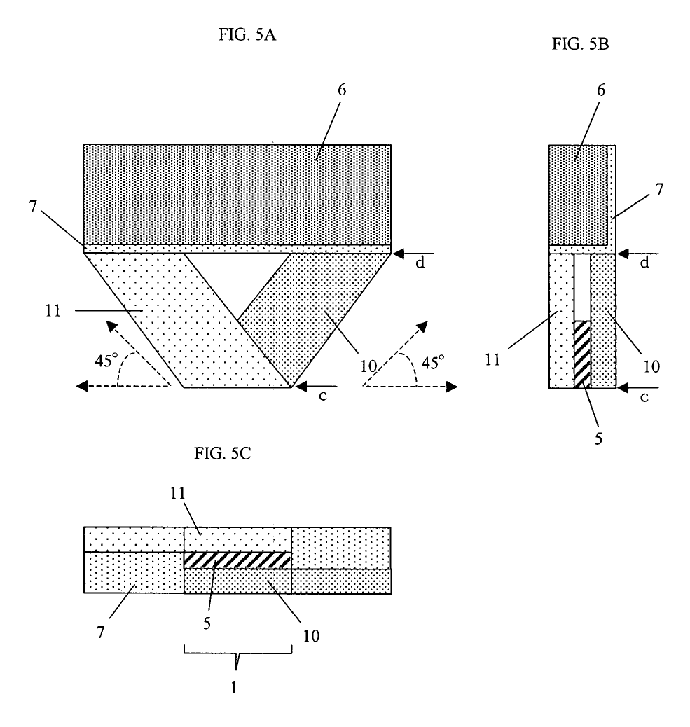

FIGS. 5A, 5B and 5C show structures of the first embodiment of a magnetic read head of the present invention. FIG. 5A is a side elevation of the magnetic read head of the present invention viewed from the vertical direction of the film surface. FIG. 5B is a cross-sectional view of the magnetic read head of the present invention cut at the center thereof, and FIG. 5C is a side elevation of the magnetic read head of the present invention viewed from the medium facing plane.

In FIGS. 5A, 5B and 5C, a first free-magnetic layer 10, a non-magnetic layer 5, and a second free-magnetic layer 11 are sequentially laminated on a substrate in the composition of Al₂O₃-TiC, the free-magnetic layer 10 is made of CoFe in the thickness of 4 nm, the non-magnetic layer 5 is made of Cu in the thickness of 1.5 nm, and the second free-magnetic layer 11 is made of CoFe in the thickness of 4 nm. These laminated layers are processed into the predetermined shape, and a bias applying layer 6 for applying a bias magnetic field is arranged only to the side of surface d in opposition to the medium facing plane via an underlayer 7, the bias applying layer 6 is made of CoCrPt in the thickness of 15 nm, and the underlayer 7 is made of Cr in the thickness of 1.5 nm. In other words, the first and second free magnetic layers 10,11 and the non-magnetic layer 5 are between the bias applying layer 6 and the medium, so the bias applying layer 6 is further away from the medium than the layers 5, 10 and 11. For example, These laminated layers are disposed between upper shield and lower shield.

The non-magnetic layer 5 is arranged only at the overlapping area of the first free-magnetic layer and the second free-magnetic layer. It is preferable to allocate an insulating material of Al₂O₃ or the like to the area other than the overlapping area in order to secure insulation property between the first free-magnetic layer and the second free-magnetic layer. Moreover, the bias applying layer 6 is allowed to be formed in the laminated structure of a ferro-magnetic layer of CoPt or the like, an anti-ferro-magnetic layer of PdPtMn, IrMn, NiO or the like, and a soft-magnetic layer of CoFe or the like. In addition, the first free-magnetic layer or the second free-magnetic layer may also be formed in some cases of NiFe or the like and the non-magnetic layer may be formed of an insulating material such as Al₂O₃, MgO or the like. Furthermore, an underlayer of Ta or the like and a cap layer of Ta or the like may also be provided.

The magnetic read head in this embodiment is formed in the shape of parallelogram in which the first free-magnetic layer 10 and the second free-magnetic layer 11 are inclined at elevation angles of 45° in opposite directions as measured from the medium facing plane c. In addition, the non-magnetic layer 5 is located between such free-magnetic layers. In this structure, the magnetoresistive effect can be obtained with a couple of soft magnetic layers (free-magnetic layers) provided via the non-magnetic layer 5. Since the first free-magnetic layer and the second free-magnetic layer are formed in the shape of parallelograms, magnetic anisotropy is generated respectively in the longitudinal direction of the parallelogram. Magnetization of the first and second free-magnetic layers 10, 111 can be set in the constant direction under the condition that no magnetic field of medium is generated by utilizing such magnetic anisotropy.

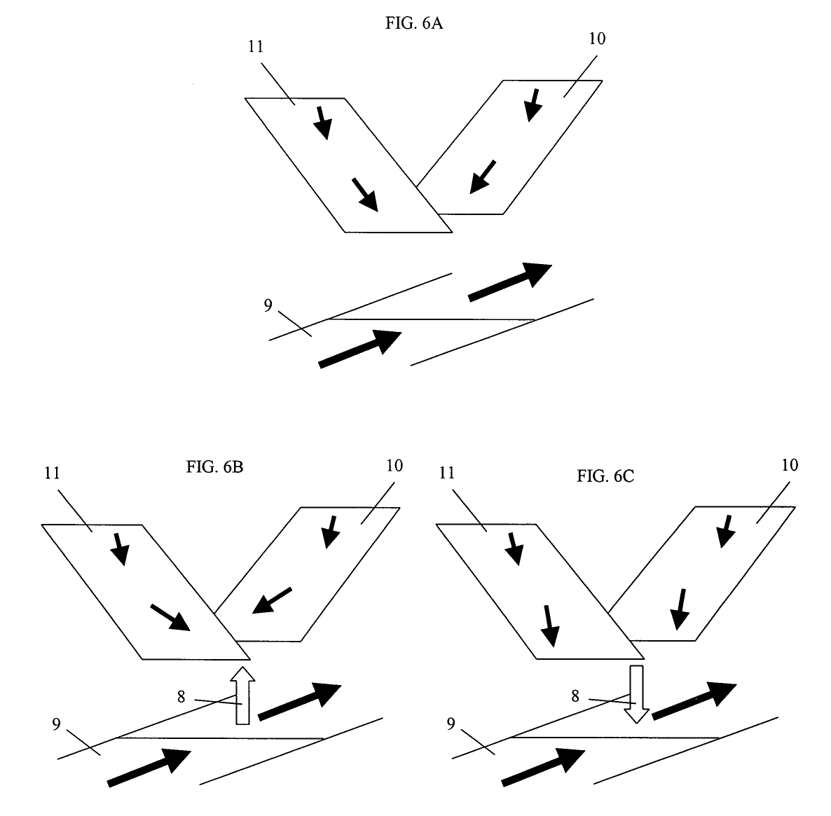

Next, response to the medium magnetic field by magnetization of the magnetic read head of the present invention will be explained. FIGS. 6A, 6b and 6C are schematic diagrams showing the magnetizing state of the first free-magnetic layer and the second free-magnetic layer in the magnetic read head in the first embodiment. First, in the state where no medium magnetic field is generated, the first free-magnetic layer 10 and the second free-magnetic layer 11 are magnetized with the shape anisotropy and the bias magnetic field from the bias applying layer in the opposite directions within the film surface of each free-magnetic layer resulting in the elevation angle of about 45° with respect to the surface c opposed to the medium.

Next, in the case where the medium magnetic field 8 is generated as shown in FIG. 6B, magnetizing directions of the first free-magnetic layer 10 and the second free-magnetic layer 11 rotate in the direction to provide an acute elevation angle for the medium facing plane c, making large the relative angle of these layers. Meanwhile, when the medium magnetic field is generated as shown in FIG. 6C, the magnetizing directions of the first and second free-magnetic layers 10, 11 rotates in the direction resulting in an obtuse elevation angle for the medium facing plane c, making small the relative angle of these layers.

In the prior art, only magnetizing angle of the free-magnetic layer rotates in response to the medium magnetic field. However, in the magnetic read head of the present invention, magnetizing directions of the first free-magnetic layer 10 and the second free-magnetic layer 11 rotate respectively in the opposite directions in response to the medium magnetic field. Accordingly, change in the relative angles of these layers becomes about twice the angles in the prior art and reading output also becomes about twice the output in the prior art.

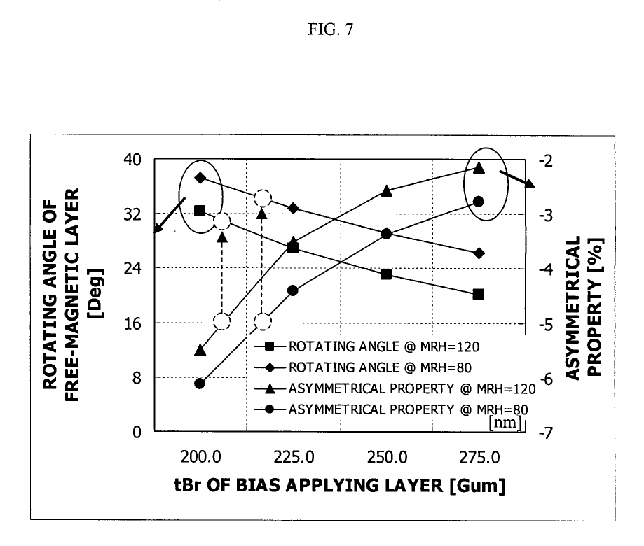

FIG. 7 shows relationships among rotating angle of the free-magnetic layer, asymmetrical property of reading waveform in the magnetic head of the prior art, and tBr of the bias applying layer. Here, rotating angle of the free-magnetic layer means the maximum rotating angle of the free-magnetic layer rotating in accordance with the medium magnetic field. FIG. 7 shows the results of simulation under the conditions that core width of magnetic head is 84 nm, element heights are 80 nm and 120 nm, and distance between the magnetic head and medium is 14 nm.

When tBr of the bias applying layer decreases, bias magnetic field applied to the free-magnetic layer also decreases and thereby the rotating angle of the free-magnetic layer corresponding to the medium magnetic field increases. Meanwhile, however, magnetic domain control of the free-magnetic layer becomes weak, resulting in a certain possibility for generation of Barkhausen noise. Since asymmetry of the reading waveform increases when the Barkhausen noise is generated, it is preferable that asymmetry is set within the value of ±5%. The rotating angle of the free-magnetic layer is within the range of 30° to 34° from FIG. 7 when asymmetry is set within the value of ±5%.

Here, a reading output of the magnetic read head is expressed by the following expression (1).
ΔV=(½)×ΔR×(1−COS θ)×Is (1)

ΔV is a reading output, ΔR is maximum magnetic resistance change, θ is relative angle between magnetizing directions of the first free-magnetic layer and the second free-magnetic layer, and Is is sense current. It is desirable that the first and second free-magnetic layers are magnetized within rotation of 30° or less. In this case, satisfactory reading output can be obtained when the angles between the magnetization of the first and second free-magnetic layers 10 and 11 and the medium facing plane c are within the range of 30 to 60° under the condition that no medium magnetic field is generated. The reason is that if the angle of elevation with respect to the medium facing plane c is set to 30° or less, the relative angle between the magnetizing directions of the first and second free-magnetic layers becomes 180° or more in some cases, making it impossible to obtain linear reading output. Moreover, if the angle of elevation for the medium facing plane c is set to 60° or more, the relative angle between the magnetizing directions of the first and second free-magnetic layers becomes parallel, also making it impossible to obtain linear reading output.

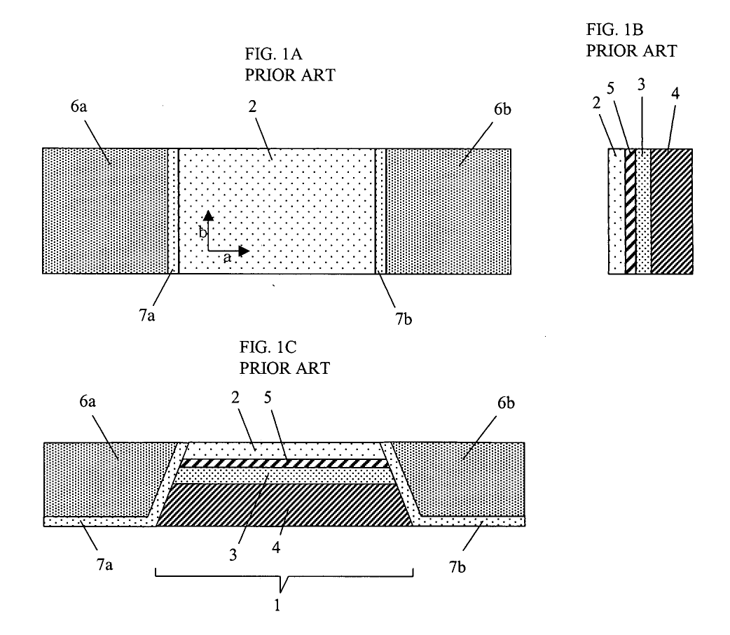

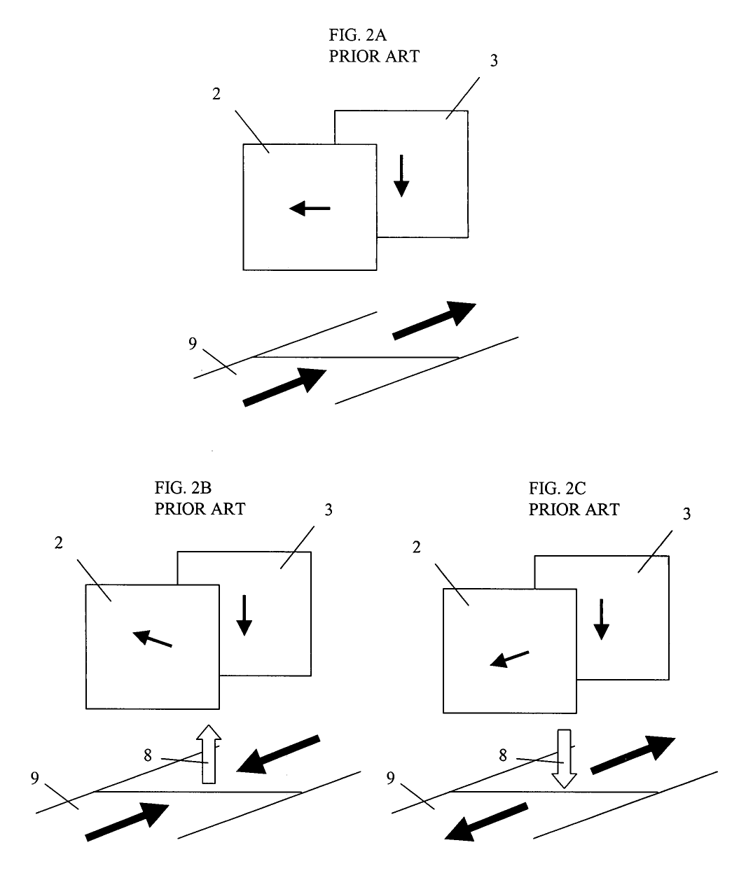

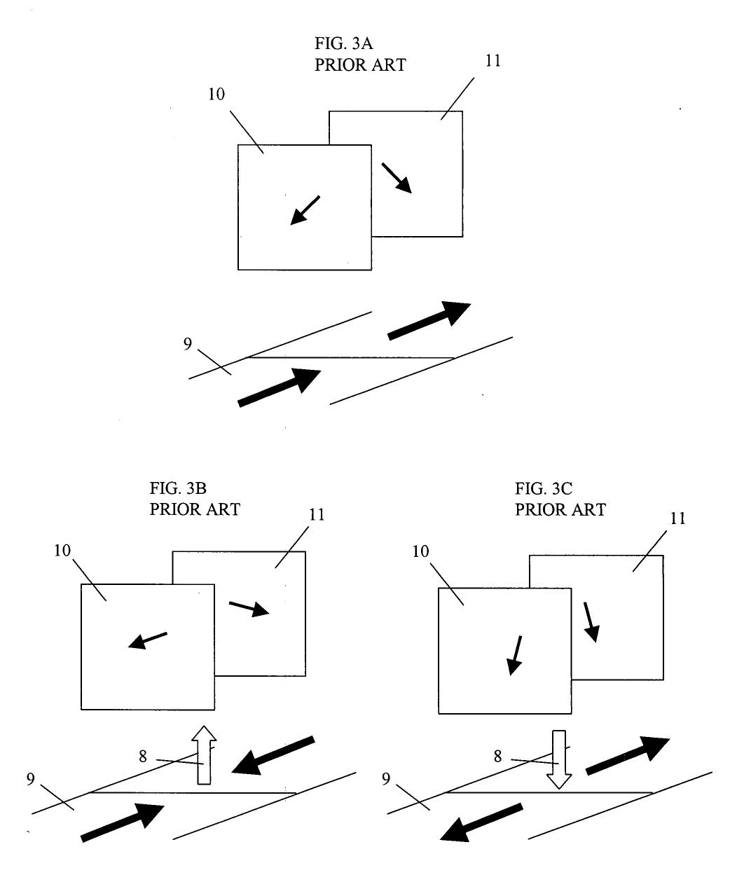

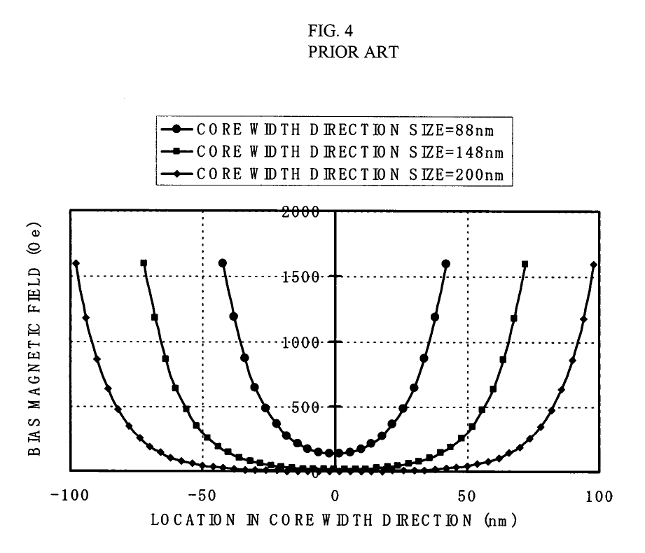

Moreover, as shown in FIGS. 1A, 1B and 1C, rotation of magnetization of the free-magnetic layer 2 at both end portions of the element is reduced due to the magnetic field of the bias applying layer 6 located at both end portions of the element in the prior art. Particularly in the magnetic read head of narrow core width, rotation in magnetization of the free-magnetic layer 2 is reduced at the central area of element. However, in this embodiment, magnetic domain is controlled more intensively with the magnetic field of the bias applying layer in the side of the plane d in opposition to the medium facing plane c. In the side of medium facing plane c where sensitivity for medium magnetic field is higher, a large output can be obtained because magnetization of the first and second free-magnetic layers 10 and 11 is not subjected to the magnetic domain control by the bias applying layer.

Energy in magnetization of the first free-magnetic layer 10 and the second free-magnetic layer 11 becomes the maximum when these layers are magnetized in the direction vertical to a side of the parallelogram. However, in this embodiment, a large self-demagnetizing field is never generated because the first free-magnetic layer 10 and the second free-magnetic layer 11 are magnetized not in the direction vertical to a side of the parallelogram. Accordingly, even if the bias applying layer is not allocated in both end portions of the element, no Barkhausen noise is generated.

### Second Embodiment

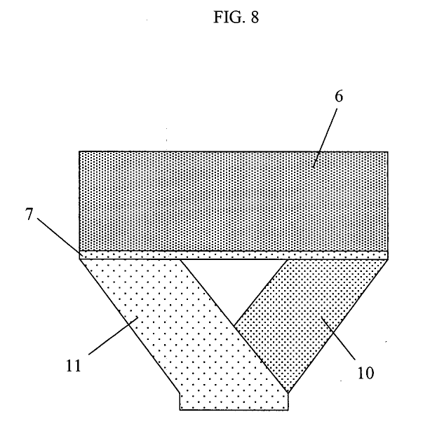

FIG. 8 shows a structure of the second embodiment of the magnetic read head of the present invention. FIG. 8 is a side elevation of the magnetic read head of the present invention viewed from the direction vertical to the film surface.

A magnetic read head of the second embodiment is constituted by extending a rectangular shape element in the side of the medium facing plane c in addition to the structure of the magnetic read head of the first embodiment. The magnetic read head can manufactured by forming a magnetoresistive element on a substrate in the desired shape and then processing the head to the predetermined size by polishing the medium facing plane of the magnetic read head. Since the element shape (core width) is not identical in the magnetic read head of the first embodiment in the direction vertical to the medium facing plane, shape of element on the medium facing plane is varied depending on a degree of polishing process. Therefore, if sufficient processing accuracy cannot be attained, characteristic of the magnetic read head generates fluctuation. Hence, in this second embodiment, the effect of the first embodiment can be attained by providing the processing part in the shape where the element shape (core width) becomes identical in the direction vertical to the medium facing plane considering fluctuation in the manufacturing process and even if higher processing accuracy cannot be attained, the magnetic read head in the predetermined core width can be manufactured.

### Third Embodiment

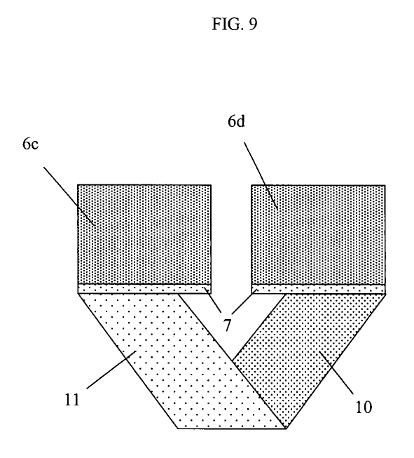

FIG. 9 shows a structure of the magnetic read head of the present invention in the third embodiment. FIG. 9 is a side elevation of the magnetic read head of the present invention viewed from the direction vertical to the film surface.

The magnetic read head of the third embodiment is constituted in the structure that the underlayer 7 and the bias applying layer 6 as the conductive layer are electrically separated into a couple of layers 6c, 6d and the respective first and second free-magnetic layers are electrically connected in the magnetic read head structure of the first embodiment. With employment of such structure, the bias applying layer 6 can be used as an electrode.

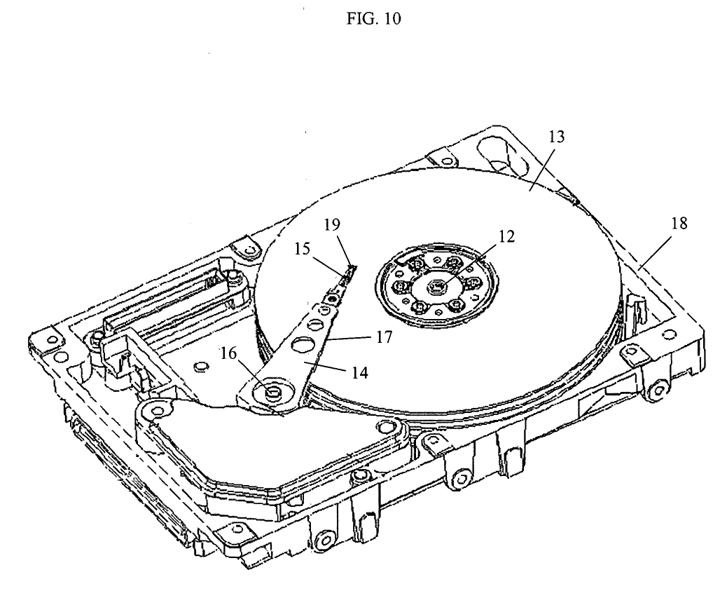

Here, a storage apparatus mounting the magnetic read head of the embodiment will be explained briefly. FIG. 10 is a perspective view of the storage apparatus using the magnetic read head of the embodiment. A magnetic disk 13 including magnetic information is rotated in higher velocity with a spindle motor 12. An actuator arm 14 is provided with a suspension 15 formed of flexible stainless steel. Moreover, the actuator arm 14 is fixed to a case 18 to rotate with a pivot 16 and moves almost in the radius direction of the magnetic disk 13. Accordingly, a slider 19 mounted to the suspension 15 moves on the magnetic disk 13 to record or read information on the predetermined track. Within the case 18, a detecting circuit is fixed to detect recording and reading signals. The detecting circuit detects a resistance value and recovers the information from a medium by measuring change in the voltage at the magnetoresistive element through application of a sense current into the magnetoresistive element in the magnetic read head.

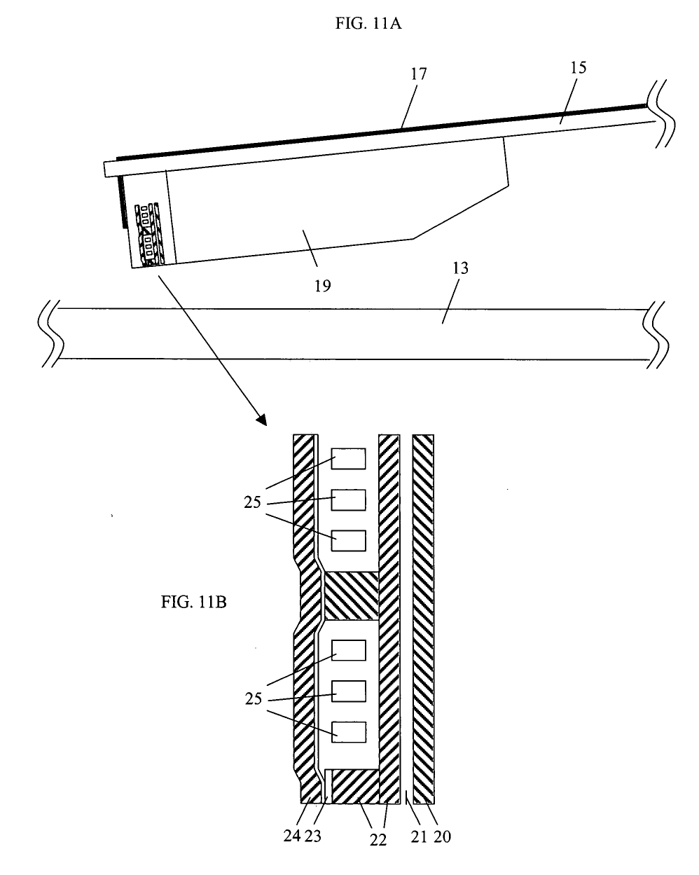

FIG. 11A is a schematic diagram showing positional relationship among the suspension 15, slider 19 in FIG. 10 and the magnetic read head of the embodiments shown in FIGS. 5A, 5B and 5C, FIG. 8 and FIG. 9. The slider 19 is mounted to the suspension 15 at the lower part thereof to constitute a head suspension assembly. When the magnetic disk 13 rotates in higher velocity, the air is drawn into a gap between the slider 19 and the magnetic disk 13 and thereby the slider 19 is levitated with such air pressure. The magnetic read head mounted at the front end part of the slider 19 is electrically connected to the detecting circuit via an insulated conductive lead wire 17 on the suspension 15 and actuator arm 14.

FIG. 11B shows structures of the magnetic read head and magnetic write head of this embodiment shown in FIGS. 5A, 5B and 5C, FIG. 8 and FIG. 9. The magnetic read head 21 is constituted in the structure that it is held with a lower shield 20 and an upper shield 22. The write magnetic head is constituted with a lower magnetic pole 22 as the upper shield, an upper magnetic pole 24 allocated in both sides of a write gap 23 and a recording coil 25. The magnetic read head 21 and the write magnetic head are allocated adjacently.

In the case where the medium magnetic field leaked from the magnetic disk 13 in accordance with recorded magnetic information is impressed to the magnetic read head 21 of this embodiment held by the lower shield 20 and the upper shield 22, change in the relative angles in magnetizing directions of the first free-magnetic layer and the second free-magnetic layer becomes about two times that of the magnetic read head of the prior art because magnetizing directions of the first and second free-magnetic layers respectively rotate independently as shown in FIG. 6B and FIG. 6C. Accordingly, it is now possible to provide the storage apparatus assuring higher recording density and larger recording capacity by detecting resistance change in accordance with the relative angle in magnetization as an electrical signal through the conductive lead wire.

According to the magnetoresistive magnetic read head of the present invention, a high output can be obtained. Thereby, it is possible to provide a magnetic read head corresponding to high density recording and a large capacity storage apparatus.

What is claimed is:

1. A magnetic read head reading from a medium forming a medium facing plane comprising:
a first free-magnetic layer;
a second free-magnetic layer;
a non-magnetic layer provided between said first free-magnetic layer and said second free-magnetic layer; and
a bias applying layer for applying a bias magnetic field in the vertical direction to the medium facing plane of said first free-magnetic layer and said second free-magnetic layer;
wherein, shape anisotropies of magnetization of said first free-magnetic layer and said second free-magnetic layer are inclined in the opposite direction with each other for the medium facing plane within film surfaces of respective free-magnetic layers,
said first free-magnetic layer and said second free-magnetic layer are overlapped at the medium facing plane in the vertical direction at the surfaces of respective free-magnetic layer films, and
said bias applying layer is located on the opposite plane to the medium facing plane of said first free-magnetic layer and said second free-magnetic layer.

2. The magnetic read head according to claim 1,
wherein angles of elevation in the shape anisotropies of magnetization of said first free-magnetic layer and said second free-magnetic layer are opposed with each other and are in the range of 30 to 60° for the medium facing plane within the film surface of respective free-magnetic layers.

3. The magnetic read head according to claim 2,
wherein said first free-magnetic layer and said second free-magnetic layer are in the shape of parallelograms inclined in the opposite directions for the medium facing plane within the film surfaces of respective free-magnetic layers, and
the base of parallelogram of said first free-magnetic layer and the base of parallelogram of said second free-magnetic layer are located on the medium facing plane and are also arranged in the vertical direction at the film surface of respective free-magnetic layers.

4. The magnetic read head according to claim 2,
wherein said first free-magnetic layer and said second free-magnetic layer are respectively constituted with the parallelogram portions in the shape of parallelogram inclined in the opposite directions with each other for the medium facing plane within the film surface of respective free-magnetic layers and rectangular portions in the shape of rectangle with the base of said parallelogram defined as one side of the rectangle,
the rectangular portions of said first free-magnetic layer and said second magnetic-layer are overlapped in the vertical direction at the film surface of respective free-magnetic layers, and
the plane opposite the plane in contact with the base of said parallelogram portions of said rectangular portions is the medium facing plane.

5. The magnetic read head according to claim 1,
wherein said non-magnetic layer is provided only at the overlapping portions in the vertical direction at the film surface of said first free-magnetic layer and said second free-magnetic layer and is formed of a conductive material.

6. The magnetic read head according to claim 2,
wherein said non-magnetic layer is provided only at the overlapping portions in the vertical direction at the film surface of said first free-magnetic layer and said second free-magnetic layer and is formed of a conductive material.

7. The magnetic read head according to claim 5,
wherein said non-magnetic layer is formed of an insulating material.

8. The magnetic read head according to claim 6,
wherein said non-magnetic layer is formed of an insulating material.

9. The magnetic read head according to claim 1,
wherein said bias applying layer is constituted with a couple of bias applying layers which are formed of a conductive material and are electrically isolated, and respective bias applying layers are electrically connected with the first free-magnetic layer or the second free-magnetic layer.

10. The magnetic read head according to claim 2,
wherein said bias applying layer is constituted with a couple of bias applying layers which are formed of a conductive material and are electrically isolated, and respective bias applying layers are electrically connected with the first free-magnetic layer or the second free-magnetic layer.

11. A storage apparatus comprising:
A magnetic read head having, a first free-magnetic layer, a second free-magnetic layer, a non-magnetic layer provided between said first free-magnetic layer and said second free-magnetic layer, and a bias applying layer for applying a bias magnetic field in the vertical direction to the medium facing plane of said first free-magnetic layer and said second free-magnetic layer, wherein, shape anisotropies of magnetization of said first free-magnetic layer and said second free-magnetic layer are inclined in the opposite direction with each other for the medium facing plane within film surfaces of respective free-magnetic layers, said first free-magnetic layer and said second free-magnetic layer are overlapped at the medium facing plane in the vertical direction at the surfaces of respective free-magnetic layer films, and said bias applying layer is located on the opposite plane to the medium facing plane of said first free-magnetic layer and said second free-magnetic layer for reading recorded information from a magnetic disk;
a flexible suspension bonded with said magnetic read head;
an actuator arm to freely rotate and fix the end part of said suspension; and
a detecting circuit device which is electrically connected with said magnetic head through an insulated lead-wire provided on said suspension and said actuator arm in order to detect an electrical signal read by said magnetic read head from a magnetic disk.

12. The storage apparatus according to claim 11,
wherein angles of elevation in the shape anisotropies of magnetization of said first free-magnetic layer and said second free-magnetic layer are opposed with each other and are in the range of 30 to 60° for the medium facing plane within the film surface of respective free-magnetic layers.

13. The storage apparatus according to claim 12,
wherein said first free-magnetic layer and said second free-magnetic layer are in the shape of parallelograms inclined in the opposite directions for the medium facing plane within the film surfaces of respective free-magnetic layers, and
the base of parallelogram of said first free-magnetic layer and the base of parallelogram of said second free-magnetic layer are located on the medium facing plane and are also arranged in the vertical direction at the film surface of respective free-magnetic layers.

14. The storage apparatus according to claim 12,
wherein said first free-magnetic layer and said second free-magnetic layer are respectively constituted with the parallelogram portions in the shape of parallelogram inclined in the opposite directions with each other for the medium facing plane within the film surface of respective free-magnetic layers and rectangular portions in the shape of rectangle with the base of said parallelogram defined as one side of the rectangle,
the rectangular portions of said first free-magnetic layer and said second magnetic-layer are overlapped in the vertical direction at the film surface of respective free-magnetic layers, and
the plane opposite the plane in contact with the base of said parallelogram portions of said rectangular portions is the medium facing plane.

15. The storage apparatus according to claim 11,
wherein said non-magnetic layer is provided only at the overlapping portions in the vertical direction at the film surface of said first free-magnetic layer and said second free-magnetic layer and is formed of a conductive material.

16. The storage apparatus according to claim 12,
wherein said non-magnetic layer is provided only at the overlapping portions in the vertical direction at the film surface of said first free-magnetic layer and said second free-magnetic layer and is formed of a conductive material.

17. The storage apparatus according to claim 15,
wherein said non-magnetic layer is formed of an insulating material.

18. The storage apparatus according to claim 16,
wherein said non-magnetic layer is formed of an insulating material.

19. The storage apparatus according to claim 11,
wherein said bias applying layer is constituted with a couple of bias applying layers which are formed of a conductive material and are electrically isolated, and respective bias applying layers are electrically connected with the first free-magnetic layer or the second free-magnetic layer.

20. The storage apparatus according to claim 12,
wherein said bias applying layer is constituted with a couple of bias applying layers which are formed of a conductive material and are electrically isolated, and respective bias applying layers are electrically connected with the first free-magnetic layer or the second free-magnetic layer.
